(19) United States
(12) Patent Application Publication
(10) Pub. No.: US 2006/0044135 A1
(43) Pub. Date: Mar. 2, 2006

(54) Apparatus and method for collision avoidance

(76) Inventors: Robert Kagermeier, Nurnberg (DE); Donal Medlar, Weisendorf (DE); Johannes Paschold, Rudolstadt (DE); Dietmar Sierk, Halle (DE)

Correspondence Address: BRINKS HOFER GILSON & LIONE, P.O. BOX 10395, CHICAGO, IL, 60610, US

(21) Appl. No.: 11/195,981

(22) Filed: Aug. 2, 2005

(30) Foreign Application Priority Data
Aug. 4, 2004 (DE) 10 2004 037 859.2

(51) Int. Cl. G08B 21/00

(52) U.S. Cl. 340/540

(57) ABSTRACT

A safety apparatus for a medical system comprises at least one source for emitting an optical signal, and at least one sensor for detecting the optical signal emitted by the at least one source. The at least one source and the at least one sensor are disposed such that an object located in a region to be monitored is detected. A control unit is provided for controlling the medical system, so that the medical system is switched into a safe operating state or interrupted if the detected object is unexpected or unwanted in the monitored region.

### BACKGROUND

The present invention relates, in general, to medical systems, and more particularly, to a safety apparatus and method for a medical system.

For medical examinations, systems often move because of their functional nature. Typical examples include MRT, CT, X-ray systems, and the like. Because of the motions of the medical systems, there is a potential risk that during operation, the medical system may collide with persons or objects that are located within a region or that mistakenly come within the region during operation. Moreover, even with medical systems that do not move, persons located in some regions can present a risk to the persons or the involved system.

There is accordingly a need for a suitable apparatus and a method by which persons or objects located in the regions can be detected, and that suitable preventative measures are taken.

One way of monitoring a radius of action of a moving medical system or machine or a region around a medical system is to use laser scanners, which furnish angle-dependent distance information. However, such technology can be extremely cost-intensive.

An alternate way is to use a patching field, which is mounted on the medical system itself and in the event of a potential collision reacts to the collision because of a pressure change and thereby brings about an immediate stop of the motion of the medical system.

However, a disadvantage of this alternate way is the lag time of the moving medical system or machine, that is, the length of time from when the potential collision is detected until the motion is finally stopped, as well as the required pressure, which needs to be relatively high, and the fact that because of the use of a patching field, the collision may not be recognized until after it has happened.

### SUMMARY

The present invention is defined by the appended claims. This description summarizes some aspects of the present embodiments and should not be used to limit the claims.

An apparatus and a method are provided which can detect danger in to avoid potential collision, can be adapted easily to various operating states of the system, and is inexpensive.

A medical system is provided, having a safety apparatus, with at least one source for emitting an optical signal and at least one sensor for detecting the optical signal emitted by the source, the source and the sensor being disposed such that unwanted objects in a region to be monitored can be detected, and having a control unit for controlling the medical system; if an unwanted object in the region to be monitored is detected by the source and the sensor, the control unit switches the medical system into a safe operating state.

A safety method for a medical system is provided, which includes: providing an optical signal via a source; detecting the optical signal emitted by the source via a sensor; disposing the source and the sensor such that unwanted objects in a region to be monitored can be detected; controlling the medical system via a control unit; and switching the system into a safe operating state, if an unwanted object in the region to be monitored is detected by the source and the sensor.

By using a source-sensor assembly, monitoring an arbitrary region around the medical system can be performed, and thus potential danger can be detected, and the operating state of the system can be adapted accordingly. Moreover, because of the disposition, the monitoring of dangerous regions can be adapted to various systems and to their directions of motion.

A use of commercially available and inexpensive sources and sensors moreover renders the cost low. On the basis of the optical signal detected by the sensor, the control unit can ascertain whether an object at which the optical signal is reflected is located in the direction of the emitted optical signal. On the basis of the optical signal detected by the sensor, the control unit calculates a distance between the source and the object at which the optical signal is reflected. The control unit changes the functioning of the medical system or stops the system, if the ascertained or determined distance from the object exceeds or undershoots a predetermined value.

At least two sources emit optical signals extending parallel to one another, or at least two sources emit optical signals not extending parallel to one another. At least one source may be movable, so that the direction of the emitted optical signal is variable. At least one source may be mounted on the system. At least one source may be mounted in proximity of the medical system. Each source is assigned precisely one sensor. The source and the assigned sensor are disposed directly side by side. The source may be an infrared light emitting diode. The source may be an infrared sensor.

Illustrative and exemplary embodiments of the invention are described in further detail below with reference to and in conjunction with the figures.

### BRIEF DESCRIPTION OF THE DRAWINGS

FIG. 1 is a schematic block diagram of a safety apparatus;

FIG. 2 shows a first example of the safety apparatus of FIG. 1;

FIG. 3 shows a second example of the safety apparatus of FIG. 1;

FIG. 4 shows a third example of the safety apparatus of FIG. 1; and

FIG. 5 schematically shows a triangulation principle employed for calculating a distance.

### DETAILED DESCRIPTION OF DRAWINGS

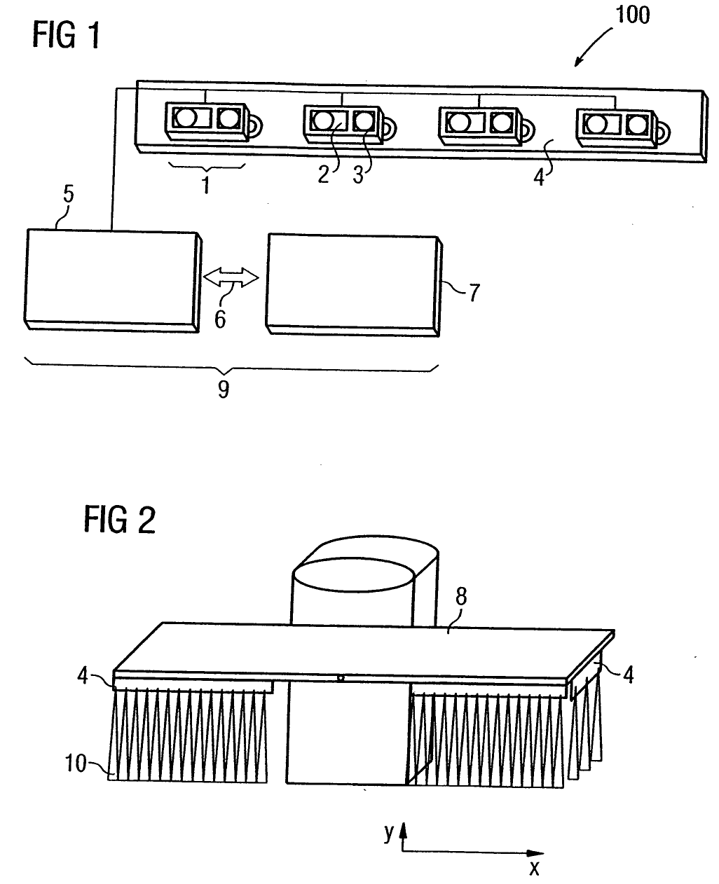

FIG. 1 shows a schematic block diagram of an apparatus 100. A source 3 and a sensor 2 each are combined into an assembly 1; that is, one sensor 2 is assigned to each source 3, and both source 3 and associated sensor 2 are disposed directly side by side. Source 3 serves or is configured to emit an optical signal 10, such as an optical signal in the infrared range. An infrared light emitting diode can be used as source 3. Sensor 2 serves or is configured to detect optical signal 10 emitted by source 3; sensor 2 can be an infrared sensor.

For assembly 1 comprising source 3 and sensor 2, a housing can be used in which source 3 and sensor 2 are disposed directly side by side at a spacing of approximately 1 cm, and in which required optical elements, such as lenses, for varying the beam, are also integrated into the housing. The size of the housing can be approximately 4 cm in length, 1 cm in width, and 1.5 cm in height. Each assembly 1 is capable of furnishing or establishing the distance from an object that is located in front of assembly 1.

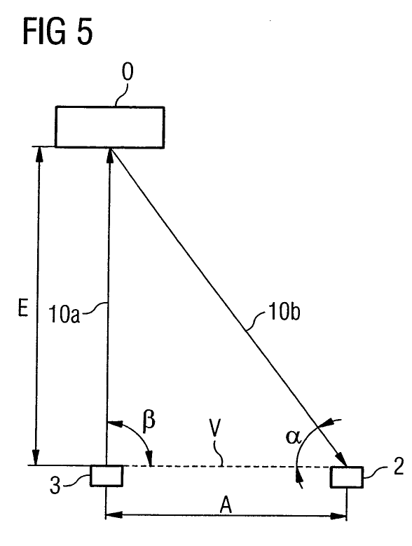

A triangulation principle employed for calculating the distance is shown schematically in FIG. 5. Source 3 and sensor 2 are shown at a spacing A apart from one another. At an initially unknown distance E from source 3, there is an object O. Source 3 emits an optical signal 10a, which is reflected by object O and is thus carried to or captured by sensor 2. By suitable triggering of source 3, a projection angle β, which is enclosed by or formed between a connecting line V between source 3 and sensor 2 and by the direction of an emitted optical signal 10a, can be varied arbitrarily. In the present example of FIG. 5, β amounts to precisely 90°. Via a position-sensitive detector apparatus and suitable lens assemblies, sensor 2 may determine an angle α that is enclosed by or formed between the connecting line V and an optical signal 10b reflected from object O. Given the angle β=90°, a known spacing A, and a known angle α, a distance E between source 3 and object O can be determined by way of the angular relationship in a right triangle; that is, in the present case, the equation is:
E=A×cot α

Analogously, using corresponding triangulation principles, spacing A can also be calculated for triangles in which β is ≠90°.

Each of the assemblies 1, that is each source 3 and sensor 2 shown in FIG. 1, may furnish distance information for object O located in front of source 3. A maximum range of such assembly 1 is approximately 80 cm. Distance information beyond the maximum measurement range is assessed as infinite. A plurality of assemblies 1 can be mounted on one patching field 4, so as to assess a plurality of signals 10 provided by assemblies 1 located side by side, and to correspondingly increase the size of the region monitored.

A control unit 9 monitors the triggering, detection and evaluation of the measurement signals. Control unit 9 comprises a microcontroller 5, which is responsible for the direct triggering of sources 3 and sensors 2, and which detects the values measured by sensors 2. Microcontroller 5 can trigger sensors 2 individually, to prevent influence from neighboring sensors 2.

Thus, each item of distance information can be associated with one individual sensor 2. Moreover, from all the measurement values furnished by sensors 2, microcontroller 5 calculates or determines whether object O is located within the measurement range of sensors 2, where object O is located, a size of object O, and whether object O is moving in any direction. In addition, microcontroller 5 may adapt the region monitored by a plurality of assemblies 1, each comprising one source 3 and one sensor 2, to motions or to existing local conditions. As such, microcontroller 5 communicates through an interface 6, such as a CAN bus, with a higher-order or master controller 7. Via interface 6, the results of detection from microcontroller 5 can be sent to the master controller 7, and as such master controller 7 can adapt the triggering of sources 3 and sensors 2 to the measurement results and to existing external conditions. For instance, a selective activation of individual sensors 2 is performed, or the sensor 2 to furnish a relative signal 10 at what time is determined, or which sensor signal to be used for evaluation is determined.

Via a plurality of sensors 2, a monitoring area in three-dimensional pace is defined. Theoretically, an area is defined in two directions from one reference point. If the area is placed in a coordinate system, for instance, then the area can be defined from an origin (reference point) in the X and Y directions, as shown in FIGS. 2 through 4. A defining and thus also demarcation in the X direction is determined by a disposition of a plurality of sources 3 and sensors 2 next to one another. Each assembly 1 expands the monitoring region in the X direction. A total number of assemblies 1 placed side by side determines a width of the area defined. The demarcation of the area in the Y direction is done via the distance information from sensors 2. The area in the Y direction is either limited by the maximum sensor range, in which case no reflection of the optical signal 10 would be detected by sensors 2, or the area is limited by objects, such as walls or the floor. In that case, optical signal 10 can be reflected by the walls or the floor and detected by sensors 2.

Accordingly, associated sources 3 and sensors 2 need not be disposed diametrically opposite one another, as in the case for instance of light gates, and as such substantial flexibility for the defined area can be achieved, and the area can be defined in arbitrary directions in space.

In FIG. 2, a first example of apparatus 100 is shown. Patching fields 4 with a plurality of assemblies 1, each comprising source 3 and sensor 2 placed side by side, are mounted on a medical system 8 for a medical examination, such as MRT, CT, X-ray system, or the like, so that a rectangular monitoring area is defined by the disposition along patching field 4 and by emitted optical signals 10.

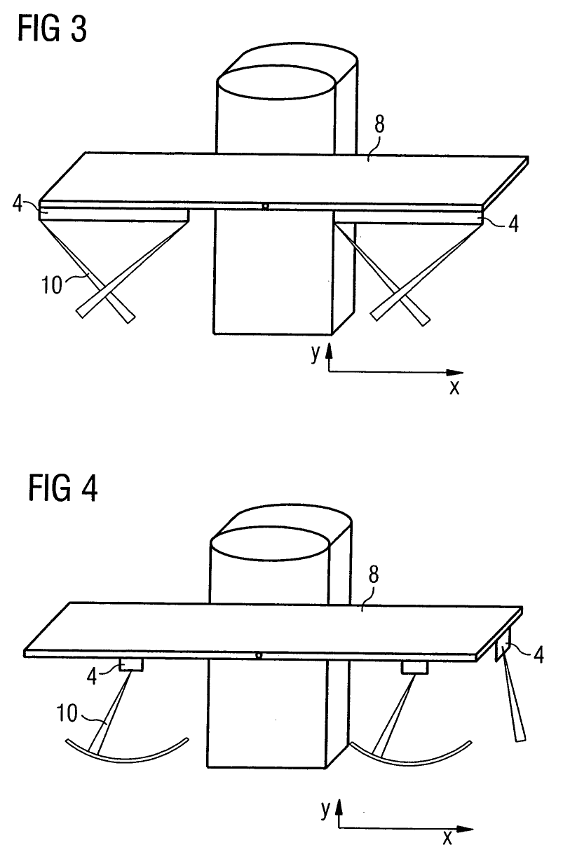

FIG. 3 shows a second example of apparatus 100. Here, to reduce the number of assemblies 1 employed, only two assemblies 1 are mounted on each patching field 4, and emitted optical signals 10 are disposed not parallel to one another but rather crossing one another.

FIG. 4 shows a third example of apparatus 100, in which only one assembly 1 is mounted on each patching field 4; corresponding source 3 is movable, so that the direction of emitted optical signal 10 is variable. The area thus defined is defined in the X direction by the known angular design of source 3 and in the Y direction by the maximum detectable distance. The area thus takes the form of part of a circular arc.

Combinations of the various examples with one another are possible, and patching fields 4 can also be mounted either on medical system 8 itself or in the vicinity of medical system 8.

From the sensor signals, a known motion of medical system 8, and a known three-dimensional environment, control unit 9 calculates from the detected signals 10 whether harmless objects are located within range of sensors 2, such as the floor or a wall, or whether there are persons or objects located in the an undesired region. If a collision of medical system 8 with objects or persons located in the range is imminent or forthcoming, control unit 9 stops or interrupts a procedure being performed by medical system 8 or changes the function of medical system 8, to prevent a collision and thus to prevent damage to persons or equipment.

Since patching fields 4 may be mounted either on medical system 8 itself or in the vicinity of medical system 8, a monitoring area may be determined at an arbitrary distance and in an arbitrary position relative to medical system 8, and thus can adapt to the area being monitored.

Using infrared light emitting diodes and infrared sensors, that is, light in the non-visible range, can avert visual irritation for persons located in the vicinity of medical system 8. Moreover, the light energy employed can be kept so slight that the infrared system is harmless to the eyes, even up close.

1. A safety apparatus for a medical system comprising:
at least one source for emitting an optical signal;
at least one sensor for detecting the optical signal emitted by the at least one source, the at least one source and the at least one sensor disposed such that an object located in a region to be monitored is detected; and
a control unit operable to switch the medical system into a safe operating state if the detected object is unexpected or unwanted in the monitored region.

2. The safety apparatus of claim 1, wherein the control unit is operable to determine whether the object is located in a direction of the emitted optical signal.

3. The safety apparatus of claim 2, wherein the control unit is operable to determine a distance between the source and the object.

4. The safety apparatus of claim 3, wherein the control unit is operable to change a functioning of the medical system or interrupt an operation of the medical system if the determined distance from the object to the optical source is less than or greater than a predetermined value.

5. The safety apparatus one claim 1, further comprising at least two sources emitting optical signals extending parallel to one another.

6. The safety apparatus of claim 1, further comprising at least two sources emitting optical signals extending non-parallel to one another.

7. The safety apparatus of claim 1, wherein the at least one source is movable, so that a direction of the emitted optical signal is variable.

8. The safety apparatus of claim 1, wherein the at least one source is mounted on the medical system.

9. The safety apparatus of claim 1, wherein the at least one source is mounted separate from the medical system.

10. The safety apparatus of claim 1, wherein each source of the at least one source is assigned only one of the at least one sensor.

11. The safety apparatus of claim 10, wherein the at least one source and the corresponding assigned sensor are disposed directly side by side.

12. The safety apparatus of claim 1, wherein the at least one source is an infrared light emitting diode.

13. The safety apparatus of claims 1, wherein the at least one sensor is an infrared sensor.

14. A safety method for a medical system, the method comprising:
emitting an optical signal with a source;
detecting the optical signal emitted by the source with a sensor;
disposing the source and the sensor so that an object located in a region to be monitored is detected; and
controlling the medical system with a control unit, the control unit switching the medical system into a safe operating state if the detected object is unexpected or unwanted in the region.

15. The safety method of claim 14, further comprising:
determining whether the detected object is located in a direction of the emitted optical signal.

16. The safety method of claim 15, further comprising:
determining the distance between the source and the detected object.

17. The safety method of claim 16, further comprising:
changing a functioning of the medical system or stopping the medical system if the determined distance from the object is less than or greater than a predetermined value.

18. The safety method of claim 14, further comprising
emitting an additional optical signal from an additional optical signal, the optical signal and the additional optical signal extending parallel to one another.

19. The safety method of claim 14, further comprising:
emitting an additional optical signal from an additional optical signal, the optical signal and the additional optical signal extending non-parallel to one another.

20. The safety method of claim 14, further comprising varying a direction of the optical signal.

21. The safety method of claim 14, wherein the optical source is mounted on the medical system.

22. The safety method of claim 14, wherein the optical source is mounted in a proximity of the medical system.

23. The safety method of claim 14, further comprising:
assigning the source to only the sensor.

24. The safety method of claim 23, further comprising:
disposing the source and the sensor directly side by side.
